(19) United States
(12) Patent Application Publication
(10) Pub. No.: US 2003/0197608 A1
(43) Pub. Date: Oct. 23, 2003

(54) Person-individual emergency recognition system

(76) Inventors: Joachim Rudhard, Leinfelden-Echterdingen (DE); Klaus Heyers, Reutlingen (DE)

Correspondence Address: KENYON & KENYON, ONE BROADWAY, NEW YORK, NY, 10004, US

(21) Appl. No.: 10/387,996

(22) Filed: Mar. 12, 2003

(30) Foreign Application Priority Data
Mar. 13, 2002 (DE) 10210975.3-32

(51) Int. Cl. G08B 1/08; G08B 23/00

(52) U.S. Cl. 340/539.18; 340/573.1; 340/539.1; 340/436

(57) ABSTRACT

A person-individual emergency recognition system, having at least one sensor for detecting at least one mechanical or other physical event having an effect on the person and for triggering a safety function, in which the at least one sensor is connected to a transmitter with which the safety function may be triggered at a predefinable or arbitrarily selectable distance with respect to the event location. The transmitter is preferably a component of a conventional mobile radio-communication system, and a device is provided for determining and transmitting the event location, for example, using a conventional global positioning system.

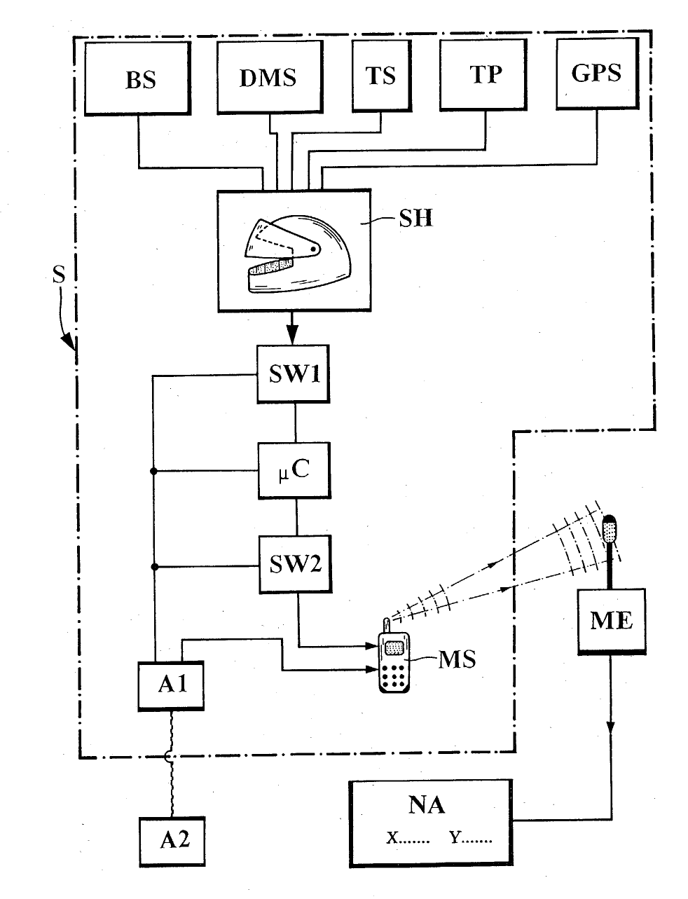

### FIELD OF THE INVENTION

The present invention relates to a person-individual emergency or accident recognition system, particularly on a head covering or a head protection like, for example, on a motorcyclist's helmet.

### BACKGROUND OF THE INVENTION

It is known per se that persons at risk for an accident wear sensors which, in response to certain events such as, for example, the influence of an outer force, or in response to certain movements or accelerations, generate a signal to be further processed. For example, it is known from German Patent No. 196 31 465 that a head-protection helmet for motorcyclists has mounted in it a sensor configuration by which, in the event the motorcyclist has an accident, a so-called airbag device on the helmet is able to be activated which then protects the region of the motorcyclist's head and back of the neck.

### SUMMARY OF THE INVENTION

In a further development of a person-individual emergency recognition system having at least one sensor for detecting at least one mechanical or other physical event having an effect on the person and for triggering a safety function, the present invention advantageously provides that the at least one sensor is connected to transmitting means by which the safety function may be triggered at a predefinable or arbitrarily selectable distance with respect to the event location.

The transmitting means may advantageously be a component of a radio-communication system that is designed at least for transmitting and evaluating emergency calls. It is particularly advantageous if a device for determining the event location, in which the data of the event location are able to be co-transmitted via the transmitting means, is present with the person to be monitored. The radio-communication system for transmitting the emergency call may simply be a conventional mobile radio-communication system for speech and/or data traffic, and the device for determining the event location, the coordinates of the event location, may be coupled in a simple manner to a conventional global positioning system (GPS).

For many application cases, particularly in the motor-vehicle sector, a GPS receiver, known per se, for example, from German Patent No. 199 63 767, is already integrated and networked with a navigation system. If, in the system according to the present invention, there is a departure from the normal operating states defined and stored in a microcontroller of the system, and limiting values are sensed lastingly or else over and above a normal time interval, so that it appears obvious that an event, say an accident, has happened to the wearer of the helmet, and he/she is therefore in a situation requiring help, then the emergency-call function is triggered.

Going into detail, the system may function in such a way that a customary or specially adapted mobile telephone, integrated in a helmet, automatically sends an emergency call to a stored, permanently staffed emergency call center. If the intactness of a mobile telephone carried along separately is ensured, it could also be provided with a special function for sending the emergency call. In so doing, the data concerning the location coordinates, ascertained by the GPS receiver, and the number of the phone subscriber are transmitted automatically. If the emergency call is not reset manually by the victim within a certain time, then the appropriately informed emergency service is able to come to the aid of the victim using the coordinates of the GPS system.

To prevent false alarms from being triggered, prior to transmitting event-relevant data, the sensor signals are compared to predefined limiting values, and only if a deviation from these limiting values in a predefined direction occurs during a predetermined time span, should the transmission for triggering the safety function be carried out. Moreover, after event-relevant data has been transmitted, as already mentioned, the triggering of a safety function may still be prevented by manual resetting within a predefined time span.

In one particularly advantageous application, the sensors are disposed in a safety helmet, especially for motorcyclists (so-called integral motorcycle helmet), mountain climbers or the like. They are composed at least partially of movement sensors, acceleration sensors, strain gauges for recording mechanical deformations, thermal sensors for monitoring the contact with the person utilizing the helmet and/or optical sensors. Also provided in the safety helmet are electronic circuit means for networked evaluation and transmission of sensor signals. In this connection, the data from the sensors are evaluated and compared to the permissible values by the previously mentioned microcontroller. The emergency call function is triggered when the data sense indicate an accident.

In the emergency recognition system according to the present invention, micromechanical sensors are preferably combined to form a safety system and integrated, for example, in a safety helmet. These sensors then detect the condition of the helmet and also the movement state of the helmet and its wearer, so that the overall system monitors the proper condition by comparing the actual values to predefined limiting values.

For example, the safety helmet mentioned may be provided inside with a suitable film containing so-called strain gauges; either individual strain gauges are applied, or the strain gauges may be embedded as such in the material in the safety helmet. This network of interconnected strain gauges senses the helmet with respect to irreversible plastic deformations. If the protective function of the safety helmet is impaired because of an impact, blow or similar influence, this is indicated to the user accordingly.

The system may be supplied with voltage either via a buffer accumulator, for example, from the voltage supply of the motorcycle by way of a cable connection, or else by an accumulator likewise located in the helmet. The accumulators needed for this application case, having relatively high standby time of approximately 135 hours and longer, low weight and small dimensions, are commercially available.

Moreover, further sensors may also be mounted, with which further conditions for an emergency situation are detectable. For example, for sensing the helmet environment, for instance, whether the helmet is being worn or not, the already mentioned thermal detectors, so-called thermopiles, thermopile arrays or even simple cameras may be utilized for the evaluation. In this context, the temperature sensor supplies a comparison temperature; these sensors may also be part of a sensor box and are connected via suitable connections to a microcontroller to form an overall system.

According to another advantageous application case, the sensors are arranged directly or indirectly on persons to be monitored from the medical standpoint. For example, the system of the present invention may be used as an automatic emergency-call device in helmets of patients in hospitals, homes, etc., in combination with an existing emergency-call system. By using a suitably adapted safety helmet in combination with a call system, patients who have a tendency to fall because of their clinical situation or people with handicaps can be helped immediately after their fall by the personnel on duty.

Without an automatic emergency-call device, patients may possibly lie helpless on the floor for a longer time. Using the safety system described above, they can be helped quickly after the automatic notification of the nursing staff. Here, an internal radio-communication system could take over the transmission of the emergency call, perhaps also without location fixing.

In addition to traffic and the medical and therapeutic field, everywhere that the wearing of a safety helmet or other protective clothing is indicated, the system of the present invention may also come in useful, adapted in a simple manner accordingly.

### BRIEF DESCRIPTION OF THE DRAWINGS

The Figure shows a block diagram of a person-individual emergency recognition system in a safety helmet for motorcyclists.

### DETAILED DESCRIPTION

In the Figure, a sensor configuration S is shown schematically, from which, on the basis of corresponding block diagrams, an emergency recognition system for a safety helmet SH for a motorcyclist (not shown here) may be inferred.

For example, an acceleration sensor BS for detecting an impact or crash or a blow, and strain gauges DMS for recording the condition of safety helmet SH with regard to deformations are mounted in safety helmet SH. A temperature sensor TS or so-called thermopile TP are also positioned, with which the thermal environment in safety helmet SH is sensed, and therefore it is possible to determine whether safety helmet SH has been put on at all.

In addition, in the exemplary embodiment shown, a so-called global positioning system GPS is coupled, with which the location coordinates of the event location or accident location may be ascertained. All these individual sensors described are connected—singly, combined in groups or as a sensor box—via a signal converter SW1 as shown, to a microcontroller μC which evaluates the sensor signals for recognizing an accident according to a suitably predefined program. For example, in one specific application case, if one or more actual values exceed the tolerable limiting value, then an emergency-call function is initiated automatically.

After carrying out a possibly necessary, repeated signal conversion in a signal converter SW2, microcontroller μC generates an emergency call in a mobile radio transmitter MS that may either be incorporated in safety helmet SH or, as shown here, is a separate conventional device. The voltage for the components described may be supplied here either via an internal accumulator A1 or an external accumulator A2.

Also shown schematically in the Figure is a mobile radio receiver ME, which receives the emergency-call signal from transmitter MS and transmits it to an emergency-call signal evaluation circuit NA in which the emergency call, and particularly also the location coordinates of the accident location are evaluated, so that suitable assistance measures may be initiated. Thus, using this system, numerous human lives can be saved, because in many cases the time from the accident event until the victim is found is too long.

What is claimed is:

1. A person-individual emergency recognition system comprising:
at least one sensor for detecting at least one mechanical or other physical event having an effect on a person and for triggering a safety function; and
at least one transmitter connected to the at least one sensor for triggering the safety function at a distance with respect to an event location.

2. The system according to claim 1, wherein the distance is a predefined distance.

3. The system according to claim 1, wherein the distance is an arbitrarily selected distance.

4. The system according to claim 1, wherein the transmitter includes a component of a radio-communication system for transmitting and evaluating emergency calls.

5. The system according to claim 1, further comprising a device for determining the event location situated with the person, and wherein the data concerning the event location is co-transmitted via the transmitter.

6. The system according to claim 4, wherein the radio-communication system is a conventional mobile radio-communication system for at least one of speech and data traffic.

7. The system according to claim 5, wherein the device for determining the event location ascertains coordinates of the event location using a conventional global positioning system.

8. The system according to claim 1, wherein, prior to transmitting event-related data, sensor signals are compared to predefined limiting values, and, if a deviation from the limiting values in a predefined direction occurs during a predetermined time span, a transmission for triggering the safety function is carried out.

9. The system according to claim 1, wherein after a transmission of event-related data, the triggering of the safety function is prevented by manual resetting with a predefined time span.

10. The system according to claim 1, further comprising further sensors for detecting conditions for an emergency situation.

11. The system according to claim 1, further comprising an electronic circuit for networked evaluation and transmission of sensor signals situated in a safety helmet, the at least one sensor being situated in the safety helmet, the at least one sensor including, at least partially, at least one of: movement sensors, strain gauges for recording mechanical deformations, thermal sensors for monitoring a contact with a person using the helmet, and optical sensors.

12. The system according to claim 11, wherein the helmet is one of a motorcyclist helmet and a mountain climber helmet.

13. The system according to claim 1, further comprising an electronic circuit for networked evaluation and transmission of sensor signals situated in a region of the at least one sensor, the at least one sensor being situated, directly or indirectly, on at least one person to be monitored from a medical standpoint, the at least one sensor including, at least partially, at least one of: movement sensors, strain gauges for recording mechanical deformations, thermal sensors for monitoring a contact with a utilizing person, and optical sensors.
